(19) United States
(12) Patent Application Publication
(10) Pub. No.: US 2008/0005148 A1
(43) Pub. Date: Jan. 3, 2008

(54) Automated knowledge base of feed tags

(75) Inventors: Peter Welch, Belmont, CA (US); William Charles Mortimore, San Francisco, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: Rearden Commerce, Inc.

(21) Appl. No.: 11/478,799

(22) Filed: Jun. 30, 2006

(51) Int. Cl. G06F 17/00

(52) U.S. Cl. 707/102

(57) ABSTRACT

In one embodiment, a knowledge base is automatically built for enriching feeds coming from different sources and that have tags of different conventions, by deducting which tags go into various categories of knowledge.

### BACKGROUND

Data tags are becoming a standard convention for data from feeds. They appear on web sites, etc., and much of the tagging of data from such sites is actually being performed by users of the sites who end up “donating” the information while signing up for the tagging services. However, different sets from different sources (i.e., different web sites) may have different agreements or conventions about tag naming. When a person receives data feeds from a variety of sources, the different data sets may have a disparate variety of tags that do not identify the data types consistently.

What is clearly needed is a system and method that can help automatically build a knowledge base for enriching feeds coming from different sources and that have tags of different conventions, by deducting which tags go into various categories of knowledge.

### SUMMARY OF THE DESCRIPTION

In one embodiment, a knowledge base is automatically built for enriching feeds coming from different sources and that have tags of different conventions, by deducting which tags go into various categories of knowledge.

### BRIEF DESCRIPTION OF THE DRAWINGS

FIG. 1 shows an overview of several data sets;

FIG. 2 shows an exemplary overview of a system according to one embodiment; and

FIG. 3 shows an exemplary process for implementation of the system according to one embodiment.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

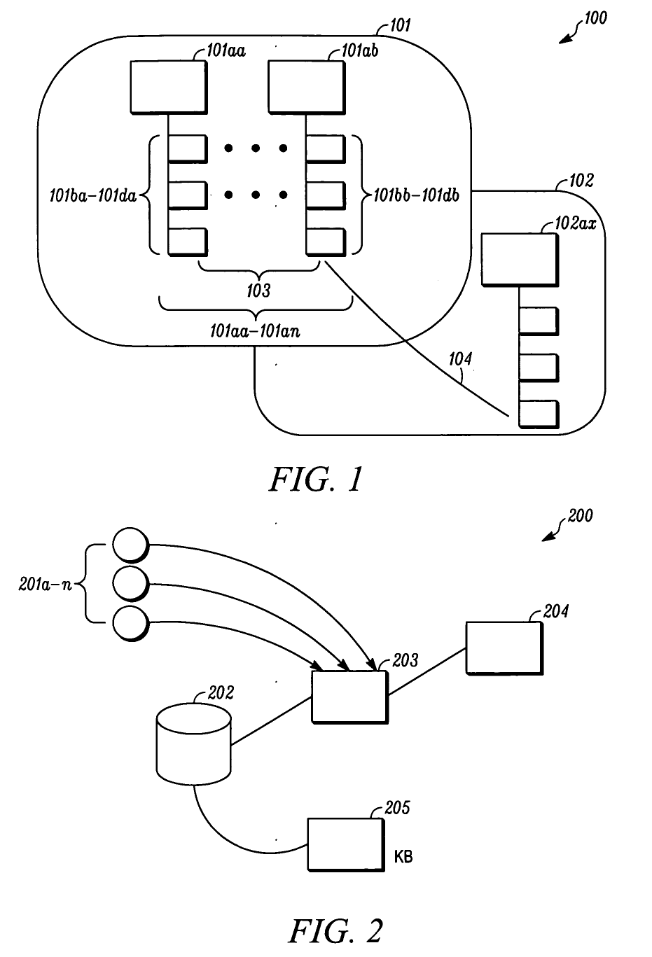

FIG. 1 shows an overview 100 of several data sets. Data set 101 may contain data item 101aa, which is tagged 101ba-101da, and data item 101ab, which is tagged 101bb-101db. In this data set 101, data tags 101da and 101db are identical, as shown by connection line 103. Data set 102 may likewise contain data item 102ax, whose last data item also has a tag that matches the tag 101db, as shown by connection line 104. In this example, for purposes of simplicity and clarity, only two data items are shown in set 101 and only one data item in set 102; however, many more data items may exist in a typical data set.

FIG. 2 shows an exemplary overview of a system 200 according to one embodiment. Feeds 201 a-n come in to server 203 with attached data tags (not shown). At server 203 the tags are filtered by software instance 204, which may use deduction engines (DE), or meta directories (MD), or in some cases extraction and transformation languages (ETL), or any useful combinations thereof to categorize and store said tags and feeds in database 202. At the same time, also in database 202 is a subset 205, which is the knowledge base created by the categorization of the different tags of different data sets (or feeds)

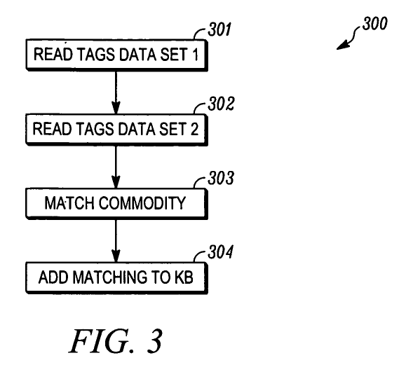

FIG. 3 shows an exemplary process 300 for implementation of the system according to one embodiment. In step 301, the system reads the data tags of data set 1 (coming from a particular feed), and in step 302 the system reads the data tags of data set 2 (coming from an other feed). In step 303, the commonalities among the tags are matched. Unmatched tags may be sent to a human editor (not shown), or in some cases, there may be additional counting (not shown), for example, that lets the matching engines set up new categories. This could be done from existing datasets, such as vertically specific databases, thesauruses, alias tables, etc This matching may be accomplished by any or several of various means known in the art, such as, for example, by using a deductive engine, or a meta-directory, or an extraction-transformation approach (using DE, MD or ETL, alone or in combination). When the matches are confirmed, the matches are added in step 304 to knowledge base 205.

In some cases, it can be also useful for enriching data sources that don't have existing tags. For instance, tags from one data source could be applied to the same object from another data source. For example, if an object, for example “Yankees” (as in the sports team) is received from a data source which is rich in tag, those tags maybe used to enrich “Yankees” from another source which has no tags. Enriching one dataset with tags of another one allows merging with or grafting on the tag taxonomies, for example, etc.

At least some embodiments, and the different structure and functional elements described herein, can be implemented using hardware, firmware, programs of instruction, or combinations of hardware, firmware, and programs of instructions.

In general, routines executed to implement the embodiments can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions can be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Some aspects can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), or firmware such as electrically erasable programmable read-only memory (EEPROM's).

In various embodiments, hardwired circuitry can be used in combination with software instructions to implement the embodiments. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent can be reordered and other operations can be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications can be made thereto without departing from the broader spirit and scope of the invention as set forth in the following claims. The specification and drawings are, accordingly, to be regarded in an illustrative sense rather than a restrictive sense.

What is claimed is:

1) A method comprising:
Reading data tags from a first data item received from a network connection;
Reading data tags from a second data item received from a network connection;
Identifying commonalities between the data tags of the first data item and the data tags of the second data item.

2) The method of claim 1, further comprising recording the commonalities of the data tags into pre-identified categories.

3) The method of claim 1, further comprising recording the commonalities of the data tags into a knowledge base of a database.

4) The method of claim 2, wherein the data tags of the first data item are from a first source, and the data tags of the second data item are from a second source.

5) The method of claim 3, further comprising, prior to identifying the commonalities, filtering the data tags of the first and second data item against at least one of, or a combination of, a deduction engines (DE), a meta directories (MD), and extraction and transformation languages (ETL).

6) The method of claim 4, further comprising categorizing the tags into pre-identified categories, based on the filtering.

7) The method of claim 6, further comprising generating one or more categories for categorizing the tags.

8) The method of claim 7, wherein the generating the one or more categories includes generating the one or more categories based on at least one of, or a combination of vertical databases, thesauruses, and alias tables.

9) The method of claim 4, further comprising adding data tags from the first data item to a third data item, the third data item matching the first data item.

10) The method of claim 9, wherein the third data item received from a third source.

11) The method of claim 10, wherein the third data item as received is exclusive of data tags.

12) A machine readable medium having stored thereon a set of instructions, which when executed perform a method comprising:
Reading data tags from a first data item received from a network connection;
Reading data tags from a second data item received from a network connection;
Identifying commonalities between the data tags of the first data item and the data tags of the second data item.

13) The machine readable medium of claim 12, further comprising recording the commonalities of the data tags into pre-identified categories.

14) The machine readable medium of claim 12, further comprising recording the commonalities of the data tags into a knowledge base of a database.

15) The machine readable medium of claim 13, wherein the data tags of the first data item are from a first source, and the data tags of the second data item are from a second source.

16) The machine readable medium of claim 15, further comprising, prior to identifying the commonalities, filtering the data tags of the first and second data item against at least one of, or a combination of, a deduction engines (DE), a meta directories (MD), and extraction and transformation languages (ETL).

17) The machine readable medium of claim 15, further comprising categorizing the tags into pre-identified categories, based on the filtering.

18) The machine readable medium of claim 17, further comprising generating one or more categories for categorizing the tags.

19) The machine readable medium of claim 18, wherein the generating the one or more categories includes generating the one or more categories based on at least one of, or a combination of vertical databases, thesauruses, and alias tables.

20) The machine readable medium of claim 15, further comprising adding data tags from the first data item to a third data item, the third data item matching the first data item.
